(19) United States
(12) Patent Application Publication
(10) Pub. No.: US 2022/0057883 A1
(43) Pub. Date: Feb. 24, 2022

(54) IMAGE SIGNAL INPUT METHOD

(71) Applicant: E Ink Holdings Inc., HSINCHU (TW)

(72) Inventors: Hsiao-Yuan CHEN, HSINCHU (TW); Wen-Pin LIU, HSINCHU (TW)

(21) Appl. No.: 17/376,181

(22) Filed: Jul. 15, 2021

(30) Foreign Application Priority Data
Aug. 20, 2020 (TW) 109128458

(51) Int. Cl. G06F 3/041; G06F 3/0488; G09G 3/34

(52) U.S. Cl. CPC G06F 3/0416; G06F 3/04883; G09G 2354/00; G09G 3/348; G09G 3/344

(57) ABSTRACT

An image signal input method is suitable for a touch electronic device. The touch electronic device includes a touch reflective display panel having a plurality of pixels. The image signal input method includes inputting a full-frame signal to the touch reflective display panel when the touch electronic device is in the non-handwriting mode to update the pixels of the touch reflective display panel. When the touch electronic device is in the handwriting mode, a movement track of an object on the touch reflective display panel is sensed. According to the movement track, a local frame signal is input to the touch reflective display panel to update some of the pixels of the touch reflective display panel corresponding to the movement track.

### CROSS-REFERENCE TO RELATED APPLICATION

This application claims priority to Taiwan Application Serial Number 109128458, filed Aug. 20, 2020, which is herein incorporated by reference in its entirety.

### BACKGROUND

### Technical Field

The present disclosure relates to an image signal input method, and more particularly to an image signal input method applied to a touch electronic device.

### Description of Related Art

Some present electronic paper (e-paper) has the function of handwriting. For example, a user can use a finger or a stylus to write on the screen of the e-paper, thereby performing the functions of word processing or drawing. However, the conventional e-paper usually shows images by outputting entire frame signals, that is, updating all of the pixels of the e-paper. When the e-paper is in a handwriting mode, the e-paper will still output the entire frame signals to update all of the pixels. Thus, the user will find obvious latency of handwriting when the user writes on the e-paper. Hence, the screen of the e-paper is difficult to show the handwriting track of the user immediately, thereby causing inconvenience in operation for the user.

### SUMMARY

At least one embodiment of the disclosure provides an image signal input method to help to reduce the latency of handwriting.

The image signal input method according to at least one embodiment of the disclosure is suitable for a touch electronic device, in which the touch electronic device includes a touch reflective display panel, and the touch reflective display panel has a plurality of pixels. The image signal input method includes inputting a full-frame signal to the touch reflective display panel to update the pixels of the touch reflective display panel when the touch electronic device is in a non-handwriting mode. When the electronic device is in a handwriting mode, a movement track of an object on the touch reflective display panel is sensed. According to the movement track, a local frame signal is input to the touch reflective display panel to update some of the pixels of the touch reflective display panel corresponding to the movement track.

Based on the above, when the touch electronic device is in the handwriting mode, the touch reflective display panel will update some of the pixels corresponding to the movement track according to the local frame signal. Compared with the conventional e-paper with the handwriting function, according to at least one embodiment of the present disclosure, the touch electronic device in the handwriting mode can shorten the time for updating frames, thereby helping to reduce the latency of handwriting.

### BRIEF DESCRIPTION OF THE DRAWINGS

Reference will now be made in detail to the present embodiments of the disclosure, examples of which are illustrated in the accompanying drawings. Wherever possible, the same reference numbers are used in the drawings and the description to refer to the same or like parts.

FIG. 1 is a flow chart of an image signal input method according to at least one embodiment of the disclosure.

FIG. 2A is a block diagram of a touch electronic device suitable for performing the image signal input method in FIG. 1.

FIG. 2B is a plane view of the touch electronic device of FIG. 2A in the non-handwriting mode.

FIG. 2C is a plane view of the touch electronic device of FIG. 2A in the handwriting mode.

### DETAILED DESCRIPTION

In the following description, in order to clearly present the technical features of the present disclosure, the dimensions (such as length, width, thickness, and depth) of elements (such as layers, films, substrates, and areas) in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

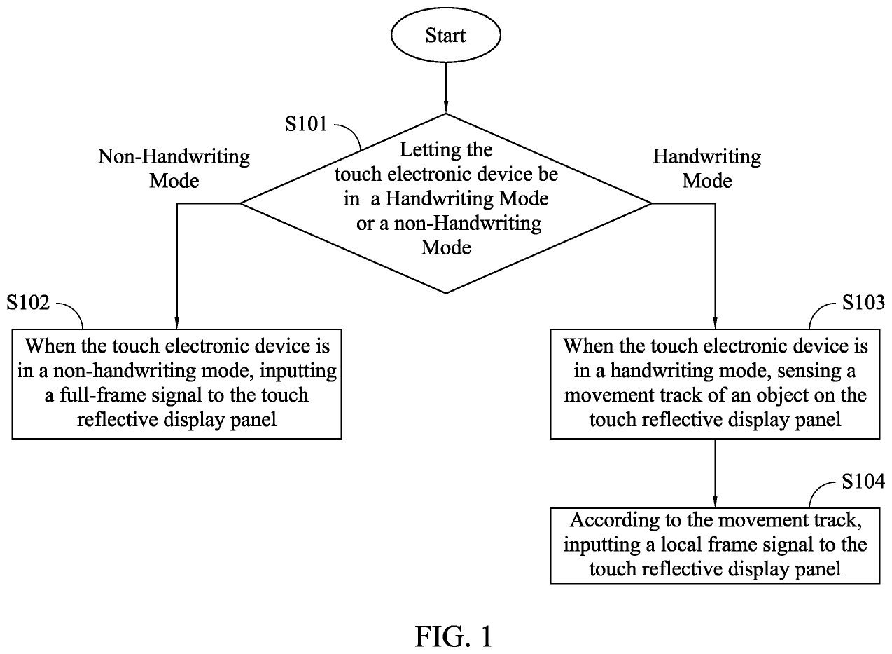

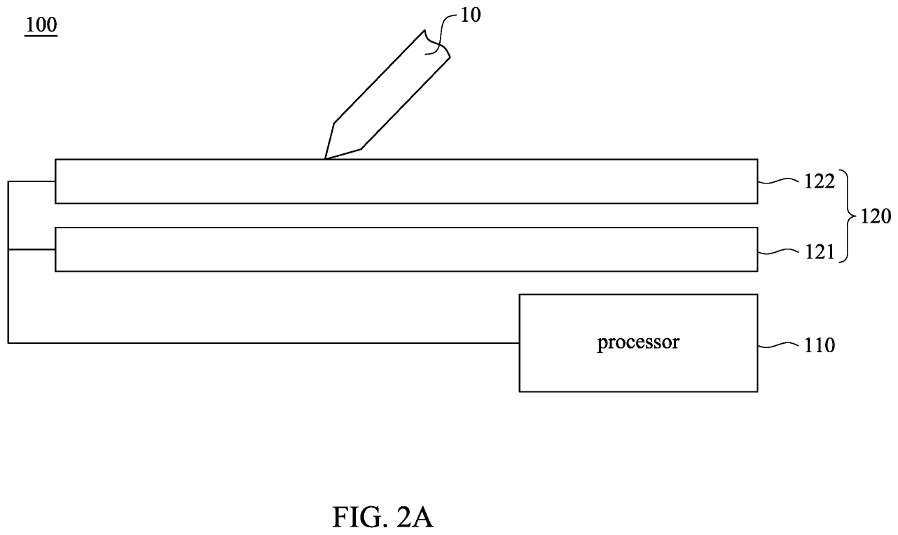

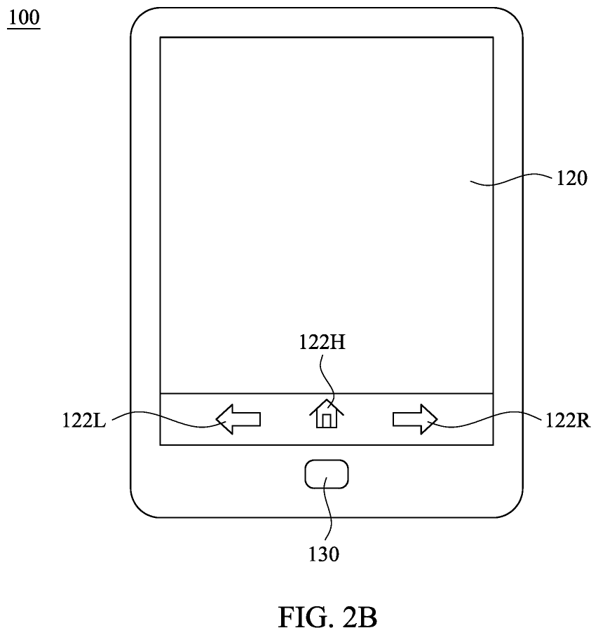

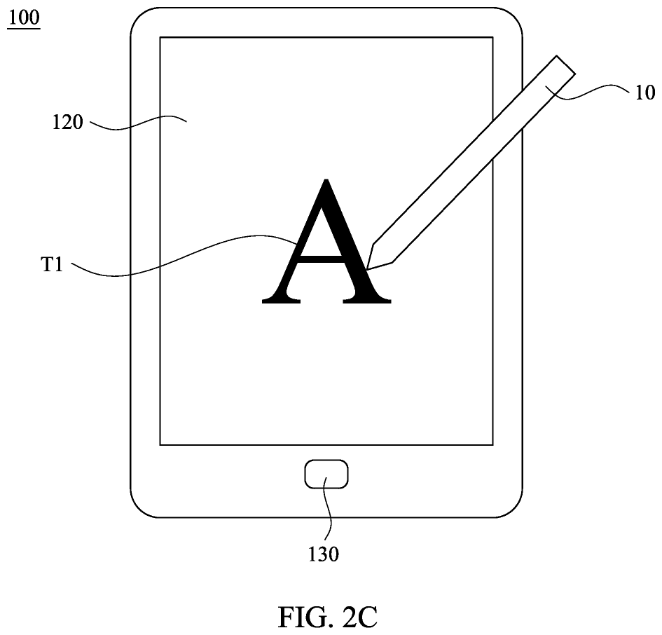

FIG. 1 is a flow chart of an image signal input method according to at least one embodiment of the disclosure, whereas FIG. 2A is a block diagram of a touch electronic device suitable for performing the image signal input method in FIG. 1. Referring to FIGS. 1 and 2A, the touch electronic device 100 can be a mobile device, such as e-paper, a smartphone, a tablet computer (commonly shortened to “tablet”), or a laptop. The touch electronic device 100 may include a processor 110 and a touch reflective display panel 120, in which the processor 110 is electrically connected to the touch reflective display panel 120, so as to control the touch reflective display panel 120.

The touch reflective display panel 120 is a pixel display panel having a plurality of pixels. The touch reflective display panel 120 has a tactile control function and can sense both the position and the movement of an object 10, in which the object 10 may be a stylus (as shown in FIG. 2A) or a finger. In the embodiment as shown in FIG. 2A, the touch reflective display panel 120 can belong in an out-cell touch display panel and include a reflective display panel 121 and a touch panel 122, in which the processor 110 is electrically connected to the touch panel 122 and the reflective display panel 121 while the touch panel 122 is attached to the reflective display panel 121. For example, the touch panel 122 can be adhered to the reflective display panel 121.

The touch reflective display panel 120 may be an electrowetting display (EWD) panel or an electrophoretic display (EPD) panel. Taking FIG. 2A for example, the reflective display panel 121 included by the touch reflective display panel 120 can be a display apparatus, which can keep showing images without electric power, for example, the electrowetting display panel or the electrophoretic display panel, etc.

It is necessary to note that in other embodiment, the touch reflective display panel 120 can belong in an on-cell or in-cell touch display panel. In other words, the reflective display panel 121 and the touch panel 122 can be integrated into one. Hence, the touch reflective display panel 120 shown in FIG. 2A is illustrated, for example, and the touch reflective display panel 120 is not limited to the out-cell touch display panel.

In the image signal input method of the embodiment, the step S101 can be executed at first, that is to say, the touch electronic device 100 is in a handwriting mode or a non-handwriting mode. Specifically, the user can make the processor 110 generate a first mode command or a second mode command according to needs for adjusting the operational mode of the touch electronic device 100. When the first mode command is generated, the touch electronic device 100 will be in the non-handwriting mode. When the second mode command is generated, the touch electronic device 100 will be in the handwriting mode.

FIG. 2B is a plane view of the touch electronic device of FIG. 2A in the non-handwriting mode. Referring to FIGS. 1 and 2B, in the embodiment of FIG. 2B, the touch electronic device 100 has a toggle Key 130, which may be a real button and used for switching the operational mode of the touch electronic device 100. When the touch electronic device 100 is in the handwriting mode, the user can press the toggle Key 130 to cause the processor 110 to generate the first mode command. The touch electronic device 100 can be switched from the handwriting mode to the non-handwriting mode according to the first mode command.

On the contrary, when the touch electronic device 100 is in a non-handwriting mode, the user can press the toggle Key 130 to cause the processor 110 to generate the second mode command. The touch electronic device 100 can be switched from the non-handwriting mode to the handwriting mode according to the second mode command. In addition, it is necessary to note that the toggle Key 130 is the real button for example, but in other embodiment, the toggle Key 130 can be replaced by the icon shown by the touch reflective display panel 120, so that it is not limited that the first and the second mode commands are generated by a real button (e.g., the toggle Key 130).

After the step S101, the touch electronic device 100 can execute the step S102 to cause the touch electronic device 100 in the non-handwriting mode. In the step S102, when the touch electronic device 100 is in the non-handwriting mode, the full-frame signal is input to the touch reflective display panel 120, so as to update all of the pixels of the touch reflective display panel 120, in which the full-frame signal can be input to the touch reflective display panel 120 via mobile industry processor interface (MIPI).

Taking FIG. 2B for example, the non-handwriting mode may be a reading mode. When the touch electronic device 100 is in the reading mode, the touch reflective display panel 120 shows not only text content (not shown), but also pagination icons 122R and 122L. At this time, the user can touch the pagination icon 122R or 122L, so as to update the frame shown by the touch reflective display panel 120.

Specifically, when the user touches the pagination icon 122R or 122L, the touch reflective display panel 120 will generate a turning-page command and then input the turning-page command to the processor 110. The processor 110 receives the turning-page command and inputs the turning-page signal to the touch reflective display panel 120 according to the turning-page command. The turning-page signal belongs in the full-frame signal, so that the touch reflective display panel 120 updates all of the pixels after receiving the turning-page signal, so as to cause the touch reflective display panel 120 to show the image of previous-page or next-page text content.

The touch electronic device 100 in the reading mode also can show a home icon 122H. When the user touches the home icon 122H, the touch reflective display panel 120 will generate a home-screen command and then input the home-screen command to the processor 110. The processor 110 receives the home-screen command and inputs the home-page signal to the touch reflective display panel 120 according to the home-screen command. The home-page signal also belongs in the full-frame signal, so that the touch reflective display panel 120 updates all of the pixels after receiving the home-page signal, so as to cause the touch reflective display panel 120 to show the image of the home-screen. Moreover, the turning-page signal and the home-page signal both can be input to the touch reflective display panel 120 via MIPI.

FIG. 2C is a plane view of the touch electronic device of FIG. 2A in the handwriting mode. Referring to FIGS. 1 and 2C, the touch electronic device 100 also can execute the step S103 after the step S101 to cause the touch electronic device 100 in the handwriting mode. In the step S103, when the touch electronic device 100 is in the handwriting mode, the touch reflective display panel 120 will sense the movement track T1 of the object 10 on the touch reflective display panel 120. Taking FIG. 2C for example, when the touch electronic device 100 is in the handwriting mode, the user can use the object 10 to write words on the touch reflective display panel 120, as the word: “A” shown in FIG. 2C, in which the word (i.e., the “A” shown in FIG. 2C) is substantially the movement track T1 of the object 10 on the touch reflective display panel 120.

After the step S103, the touch electronic device 100 executes the step S104, that is to say, the processor 110 inputs a local frame signal to the touch reflective display panel 120 according to the movement track T1. Specifically, the touch reflective display panel 120 can sense the movement track T1 to generate a corresponding touch signal. The touch reflective display panel 120 can input the touch signal to the processor 110. Then, the processor 110 can generate the corresponding local frame signal according to the touch signal and then input the local frame signal to the touch reflective display panel 120.

The touch reflective display panel 120 can update some of the pixels corresponding to the movement track T1. Specifically, according to the local frame signal, the touch reflective display panel 120 only updates the pixels which the movement track T1 occupies or is disturbed in and does not update the other pixels that no movement track T1 occupies or is disturbed in. In addition, the local frame signal can be input to the touch reflective display panel 120 via universal serial bus (USB).

Consequently, when the touch electronic device is in the handwriting mode, the touch reflective display panel will update some of the pixels corresponding to the movement track according to the local frame signal, and not update all of the pixels according to the full-frame signal. Therefore, compared with the conventional e-paper with the handwriting function, the touch electronic device in the handwriting mode according to at least one embodiment of the present disclosure can shorten the time for updating frames to help to reduce the latency of handwriting, thereby showing the handwriting track of the user immediately, so that it can improve the convenience in operation for the user.

Although the present disclosure has been described in considerable detail with reference to certain embodiments thereof, other embodiments are possible. It will be apparent to those skilled in the art that various modifications and variations can be made to the structure of the present disclosure without departing from the scope or spirit of the disclosure. Therefore, the spirit and scope of the appended claims should not be limited to the description of the embodiments contained herein.

What is claimed is:

1. An image signal input method, suitable for a touch electronic device, wherein the touch electronic device comprises a touch reflective display panel having a plurality of pixels, and the image signal input method comprises:
when the touch electronic device is in a non-handwriting mode, inputting a full-frame signal to the touch reflective display panel to update the pixels of the touch reflective display panel;
when the touch electronic device is in a handwriting mode, sensing a movement track of an object on the touch reflective display panel; and
according to the movement track, inputting a local frame signal to the touch reflective display panel to update some of the pixels of the touch reflective display panel corresponding to the movement track.

2. The image signal input method of claim 1, wherein the non-handwriting mode is a reading mode.

3. The image signal input method of claim 1, wherein the touch reflective display panel is an electrowetting display panel or an electrophoretic display panel.

4. The image signal input method of claim 1, wherein the full-frame signal is inputted to the touch reflective display panel by MIPI when the touch electronic device is in the non-handwriting mode.

5. The image signal input method of claim 1, wherein the local frame signal is inputted to the touch reflective display panel by USB when the touch electronic device is in the handwriting mode.

6. The image signal input method of claim 4, wherein the local frame signal is inputted to the touch reflective display panel by USB when the touch electronic device is in the handwriting mode.

7. The image signal input method of claim 1, further comprising:
according to a first mode command, making the touch electronic device in the non-handwriting mode; and
according to a second mode command, making the touch electronic device in the handwriting mode.

8. The image signal input method of claim 1, wherein the step of inputting the full-frame signal to the touch reflective display panel comprises:
according to a turning-page command, inputting a turning-page signal to the touch reflective display panel.

9. The image signal input method of claim 1, wherein the step of inputting the full-frame signal to the touch reflective display panel comprises:
according to a home-screen command, inputting a home-page signal to the touch reflective display panel.
